(19) United States
(12) Patent Application Publication
(10) Pub. No.: US 2013/0213819 A1
(43) Pub. Date: Aug. 22, 2013

(54) PROCESS FOR MANUFACTURING LOWER CHLORIDES OF TITANIUM

(71) Applicant: Keki Hormusji Gharda, Bandra (West) Mumbai (IN)

(72) Inventor: Keki Hormusji Gharda, Bandra (West) Mumbai (IN)

(21) Appl. No.: 13/883,009

(22) PCT Filed: Oct. 24, 2011
(86) PCT No.: PCT/IN11/00734

§ 371 Date: May 2, 2013

(30) Foreign Application Priority Data
Nov. 2, 2010 (IN) 3042/MUM/2010

(51) Int. Cl. C01G 23/02; C25C 3/28

(52) U.S. Cl. CPC C01G 23/02; C25C 3/28
USPC 205/398; 423/492

(57) ABSTRACT

A process for preparation of lower chlorides of titanium is provided, in which titanium tetrachloride (TiCl4) is reduced using a reducing agent in at least one molten alkali metal salt at a temperature of about 300 to about 1400° C. to obtain a reduced mass containing lower chlorides of titanium. A process for preparation of titanium metal from the lower chlorides of titanium is also provided.

### CROSS-REFERENCE TO RELATED APPLICATIONS

This application is a National Stage Entry of PCT/IN2011/000734, filed Oct. 24, 2011, which claims priority to Indian Patent Application No. 3042/MUM/2010, filed Nov. 2, 2010.

### BACKGROUND

1. Field of Invention

The present invention relates to preparation of chlorides of Titanium in a medium containing electrolytes suitable for electrochemical production of highly pure Titanium metal.

2. Discussion of Related Art

Titanium and its alloys exhibit excellent properties such as hardness, corrosion resistance and high temperature strength. They are widely used as a strategic metal in many applications including defense and aerospace applications. Titanium is currently produced by the metallothermic reduction processes. These processes are associated with various drawbacks such as: i) these processes are batch processes; ii) these processes have low productivity and high energy consumption; and iii) these processes involve multistage processing to remove the contamination. There were several processes attempted in the past but none of them was able to replace the existing process.

In the recent past there are several other new electrochemical and reduction processes claimed to replace the existing metallothermic processes but none of them is commercialized yet. The electrochemical production of Titanium metals predictably is the superior production route but is yet to reach the commercialization stage.

The electrolysis of Titanium from its chlorides has many advantages over the ones from its oxides. Titanium tetra chloride, which is the starting material for all Titanium chloride processes, is a covalent compound and can't be electrolyzed directly. It can be electrolyzed from its chloro complexes in alkali and alkaline metal chlorides through successive reduction steps as Ti⁴⁺→Ti³⁺→Ti²⁺→Ti⁰.

Further, the gaseous TiCl₄ is very less soluble in molten alkali and alkaline electrolyte system and suffers from serious problem of back reactions during electrolysis with very poor current yield. However, the lower chlorides have high solubility in the alkali and alkaline chloride melts and forms a number of chloro complexes, which are highly conductive and suitable medium for electrolysis of Titanium. There are a number of processes for Titanium by electrolysis using lower chlorides of Titanium containing bath. The production of highly pure lower chlorides of Titanium by reduction of gaseous Titanium tetra chlorides in vapor phase suffers from low yield, contamination and oxidation during handling.

Apart from this, TiCl₃ manufacturing methods hitherto used have several drawbacks such as low conversion/yield, high cost of equipment and operations. For example, TiCl₄ and H₂ reacted using electric arc using Tungsten electrodes results in poor yield at exorbitant cost. Method of using heating and sudden quenching also has lower yield and high energy losses.

In Z.anorg. Chem.,219, 299(1959) Ehrlich et al. reported that TiCl₃ forms stable binary melts with all the alkali metal chlorides due to the formation of anionic complexes TiCl₆³⁻, TiCl₅²⁻ and TiCl₄⁻.

Komarek et al., in J. Electrochemical Soc. 105, 4(158) reported that TiCl₃ forms TiCl₄²⁻ of Me₂TiCl₄ type with alkali metal chlorides. The TiCl₂ and TiCl₃ form a ternary black salt with NaCl of corresponding composition 9NaCl. 2TiCl₃. TiCl₂ in the melt.

Bluetial et al., reported a method for the preparation of lower valence halide of Titanium using Ti (alloyed with up to 4% carbon) in a molten salt bath. The lower valence Titanium halides (TiCl₃/TiCl₂) are dissolved in the molten salt and both are of special importance in the production of Ti metal whereas TiCl₄ cannot be electrolyzed because they do not ionize sufficiently to conduct the electricity and they cannot be dissolved in molten alkali or alkaline earth halide bath.

U.S. Pat. No. 2,741,588 discloses a high temperature process for electrolytically producing Titanium metal from Titanium tetrachloride in an electrolytic cell having a fused salt electrolyte selected from the group consisting of alkali metal halides, alkaline earth metal halides, magnesium halides and mixture thereof, a non-consumable anode, a solubilization cathode and a deposition cathode.

Furthermore, U.S. Pat. No. 5,372,681 discloses a method for preparing a composition consisting essentially of trivalent aluminum and divalent titanium, said method comprising heating in an inert atmosphere a mixture comprising (1) at least one aluminum halide, (2) elemental aluminum, (3) at least one titanium halide where titanium is in the trivalent or tetravalent state, and (4) at least one salt capable of forming a melt with said aluminum halide at temperatures up to about 250° C. to form a molten homogeneous mass and for a time to effect reduction of said titanium halide by said elemental aluminum.

The method disclosed in U.S. Pat. No. 5,372,681 is based on the production of divalent titanium by the reduction of higher valence titanium halides by aluminum in a molten salt electrolyte which renders the process more expensive and complex. Furthermore, the process is silent about recovery and recycling of the reagents.

Accordingly it is desirable to develop a simple process for preparing lower chlorides such as TiCl₃ and TiCl₂ by quantitative reduction of titanium tetrachloride.

### SUMMARY OF THE INVENTION

It is an object of the present invention to provide a process for preparing lower chlorides such as TiCl₃ and TiCl₂by quantitative reduction of titanium tetrachloride with Hydrogen.

It is another object of the present invention to provide a process which avoids escape of Titanium tetrachloride or lower chlorides generated as intermediate products by trapping and de-volatilizing with alkali metal salt.

It is still another object of the present invention to provide a process which is simple, high yielding, economic and safe.

It is yet another object of the present invention to provide a process which recovers the un-reacted TiCl₄ and recycles the recovered TiCl₄.

It is a further object of the present invention to provide a process which involves recycling of excess hydrogen after absorbing the HCl formed.

In accordance with the present invention there is provided a process for the preparation of lower chlorides of Titanium; said process comprising reduction of Titanium Tetrachloride (TiCl₄) using a reducing agent in at least one molten alkali metal salt at a temperature of about 300 to about 1400° C. to obtain a reduced mass containing lower chlorides of Titanium.

Typically, the reducing agent is hydrogen (H₂).

Typically, the mole ratio of H₂ to TiCl₄ is in the range of about 1:1 to 8:1, preferably the mole ratio of H₂ to TiCl₄ is 1:1.

Typically, the alkali metal salt is at least one selected from the group consisting potassium chloride, sodium chloride, calcium chloride, lithium chloride and magnesium chloride.

Typically, the lower chlorides of Titanium is at least one selected from the group consisting of titanium trichloride(TiCl₃) and titanium dichloride(TiCl₂).

Typically, the reduction is carried out at sub-atmospheric to atmospheric pressure using suitable condensing equipment.

Alternatively, the reduction is carried out at a pressure up to 20 kg/cm².

In accordance with another embodiment of the present invention the process further comprises heating the reduced mass at a temperature not less than 1000° C. in a disproportionation reactor to obtain lower chlorides of Titanium.

In accordance with still another embodiment of the present invention the process further comprises passing the reduced mass in a metallothermic reaction system containing at least one reducing metal selected from the group consisting titanium, aluminium, calcium, magnesium and sodium to produce lower chlorides of the titanium or its alloys.

In accordance with yet another embodiment of the present invention the process further comprises introducing the reduced mass containing TiCl₃ into an electrolysis cell in which the spent bath with depleted or exhausted lower chlorides is used as a medium for reduction to obtain titanium metal.

Typically, the process further comprises recycling of un-reacted or recovered TiCl₄. Typically, the process further comprises recycling of excess reducing agent after absorbing the hydrochloride formed.

### DESCRIPTION OF THE INVENTION

In accordance with the present invention there is provided a process for the preparation of lower chlorides of Titanium such as titanium trichloride(TiCl₃) and titanium dichloride(TiCl₂).

The process of the present invention involves the following steps:

In the first step, a molten alkali metal salt is prepared by taking at least one metal salt in a reactor followed by heating at a temperature of about 300 to about 1400° C. Typically, the alkali metal salt is at least one selected from the group consisting potassium chloride, sodium chloride, calcium chloride, lithium chloride and magnesium chloride.

In the next step, a vapor mixture of Titanium Tetrachloride (TiCl₄) and reducing agent (Hydrogen gas) is prepared in a vaporizer. The obtained vapor mixture is passed/bubbled through the molten alkali metal salt which subsequently causes reduction of Titanium Tetrachloride and forms reduced mass containing lower chlorides of Titanium.

The mole ratio of H₂ to TiCl₄ is maintained in the range of about 1:1 to 8:1. In accordance with the preferred embodiment of the present invention the mole ratio of H₂ to TiCl₄ is 2:1.

In accordance with one of the embodiment of the present invention the reduction is carried out at sub-atmospheric to atmospheric pressure using suitable condensing equipment.

Alternatively, the reduction is carried out at a pressure up to 20 kg/cm².

In accordance with another embodiment of the present invention the process further comprises heating the reduced mass at a temperature not less than 1000° C. in a disproportionation reactor to obtain lower chlorides of Titanium.

In accordance with still another embodiment of the present invention the process further comprises passing the reduced mass in a metallothermic reaction system containing at least one reducing metal selected from the group consisting titanium, aluminium, calcium, magnesium and sodium to produce lower chlorides of the titanium or its alloys.

In accordance with yet another embodiment of the present invention the process further comprises introducing the reduced mass containing TiCl₃ into an electrolysis cell in which the spent bath with depleted or exhausted lower chlorides is used as a medium for reduction to obtain titanium metal.

In accordance with the present invention the process further comprises recycling of un-reacted or recovered TiCl₄.

In accordance with another embodiment of the present invention the process further comprises recycling of excess reducing agent after absorbing the hydrochloride formed.

In accordance with one exemplary embodiment of the present invention TiCl₄ vapours and hydrogen, separately or together, are introduced through a series of dip pipes or a sparger for even distribution into a molten salt bath containing NaCl-KCl in suitable proportion, preferably as a eutectic, above their mixed melting point, at about 700° C. Typically, the operation can be in batch mode or in a continuous mode. The off gases are passed through i) a condenser for recovery of un-reacted TiCl₄ as a liquid, ii) a water scrubber for absorption of HCl, and ii) a suitable drying system such as sulphuric acid contactor. The resultant dry hydrogen is recycled to the main reactor along with the make up quantity of H₂.

Typically, the reducing agent is added in a mode selected from the group consisting of batch mode, continuous mode and semi continuous mode.

In one of the embodiments of the present invention the reducing agent is added with pre-heating.

In accordance with another embodiment of the present invention the reducing agent is added without pre-heating.

Typically, hydrochloride is generated as a by product and is liberated as an insoluble gas.

Typically, the reduction reaction is carried out in a metal tank of any shape and size lined with bricks such as alumina, silica, magnesia, mullite and the like.

Typically, the chemical reaction involved in the process is as follows:

2TiClₓ+H₂→2TiClₓ₋₁+2HCl

Wherein,

X is 4, 3 or 2.

Preferably, the reaction involved in the process is as follows:

2TiCl₄+H₂→2 TiCl₃+2HCl

TiCl₄+H2→TiCl₂+2HCl

The metallothermic reaction involved in the process is:

2TiCl₃+Ti→3TiCl₂

TiCl₃+Al Ti+AlCl₃

The chemical reactions forming metal complexes are as follows:

TiCl₄+2MCl→M₂TiCl₆,

TiCl₃+2MCl→M₂TiCl₅,

### Wherein,

M is alkali metal selected from Na, K and the like.

The invention will now be described with the help of the following non-limiting examples.

### EXAMPLE-1

700 gms of equimolar NaCl and KCl (308 parts of NaCl and 392 parts KCl) was taken in a clay graphite reactor. The salt mixture was purified and dried by heating and passing dry HCl and finally the reactor was degassed with inert argon gas. The reactor was heated in an electric furnace and temperature was increased slowly to 750° C. under argon atmosphere. About 1400 gm of Titanium tetrachloride liquid was taken in a steel vaporizer and passed at the rate of 200 g/hr. The reducing gas H₂ from a cylinder was bubbled through the titanium tetrachloride vaporizer. The mixture of TiCl₄ vapor and H₂ gas was bubbled in the molten salt bath through a ceramic sparger. The mole ratio of TiCl₄ to H₂ was maintained at 1:1 during reduction. The reduction of TiCl₄ yields TiCl₃ in-situ and form chloro-complexes with the alkali chlorides. The un-reacted TiCl₄ was condensed and the byproduct HCl was scrubbed in dilute alkali. The quantity of HCl generated was calculated from the change of normality of alkali solution. The TiCl₃ containing molten mass was cooled and analyzed under controlled atmosphere. The TiCl₃ content of the bath was 35% w/w with reduction efficiency of 97%.

### EXAMPLE-2

10 kg salt mixture of 32 mol % NaCl, 48 mol % KCl and 20 mol % CaCl₂ was prepared in a graphite crucible kept inside a steel reactor. The salt mixture was purified and degassed as described in example 1. The salt mixture was melted under inert nitrogen atmosphere and temperature of the melt was maintained at 700° C. The vapor mixture of TiCl₄ and H₂ was bubbled in the molten liquid. The stoichiometric ratio of 1:4 of TiCl₄ to H₂ was maintained during the reduction by controlled vaporization of TiCl₄ and passing of H₂ gas. The bubbling and dispersion of vapor mixture was carried out by putting multiple ceramic dip tubes in the molten bath. The TiCl₃ content was analyzed and was found to be 30% with efficiency of 96.5%.

### EXAMPLE-3

A molten bath was prepared by taking 25 mol % CaCl₂ and 75 mol % KCl in a brick lined reduction reactor of which the outer layer was clay graphite. The salt mixture (120 kg) was dried and melted with the help of graphite resistance heater provided at the bottom of the reactor. The reactor was sealed with high temperature rope gaskets for prevention of gas leakage.

Temperature of the reactor was maintained at 700° C. during reduction. TiCl₄ and H₂ vapor was fed through multiple clay graphite dip tubes to create agitation and dispersion in the molten bath. Reduction was carried out by passing 4500 gm per hour TiCl₄ with the reducing H₂ gas at 1:4 mole ratio. The un-reacted TiCl₄ was condensed in multiple condensers and recycled back to vaporizer. Similarly excess H₂ was passed through series of HCl scrubber and a dehydrating tower (with concentrated sulphuric acid circulation) and recycled to the reacting system. 97% conversion of TiCl₄ to TiCl₃ was confirmed

### EXAMPLE-4

As described in example 1, a molten bath was prepared by using 62.8 mol % KC1, 37.2 mol % MgCl₂ (melting point −505° C.) in a clay graphite crucible kept in steel reactor. 240 gm of Titanium tetrachloride was taken in a steel vaporizer and boiled at a rate of 60 g/hr. The reducing gas H₂ from a cylinder was bubbled in the titanium tetrachloride vaporizer. The vapor mixture of TiCl₄ and H₂ was bubbled into the molten liquid bath at 550° C. Reduction of TiCl₄ was continued for 4 hrs. TiCl₃ content in the reduced mass was 9% w/w with reduction efficiency greater than 95%.

### EXAMPLE-5

As described in example-1, a molten bath was prepared by taking 6.0 kg of 50 mol % NaCl & 50 mol % KCl in a clay graphite crucible which was kept in steel reactor. 990 gms TiCl₄ was fed into the molten bath at 750° C. for 10 hrs. Controlled vaporization of TiCl₄ and bubbling of H₂ in liquid TiCl₄ maintained the mole ratio of TiCl₄ to H₂ (1:2) during the reduction. TiCl₃ content in bath was 11.8% w/w. The reaction temperature was increased to 900° C. and disproportion reaction was continued at 210 mm Hg pressure as per the following reactions.

TiCl₄½H₂=TiCl₃+HCl,

2TiCl₃=TiCl₂+TiCl₄

TiCl₂ is formed as a complex and retained in the bath where as TiCl₄ released from bath was condensed and recycled.

The TiCl₄ vapor generated during disproportion was condensed and measured. The bath samples were analyzed for TiCl₃ and TiCl₂ content. The total Ti content of molten bath was 2.24% w/w of which 74% Ti was in the form of TiCl₂.

### EXAMPLE-6

The reduction reaction and electrolysis were carried out in two separate systems with continuous circulation. Reduction was carried out in 90 liter multi layered brick lined reactor. 125 kg equi-molar mixture of pre-dried NaCl and KCl was taken in both the reactors i.e. reduction reactor and electrolysis cell. The salt mixture was melted by passing alternating current using resistance heaters. The temperature of the molten bath was maintained at 700° C. in both the reactors. Pre-electrolysis was carried out in both the molten baths by putting graphite electrodes and passing direct current at potential below the decomposition of NaCl and KCl to remove all other metallic impurities. Reduction was carried out in reduction reactor by passing TiCl₄ and H₂ at 1:1 mole ratio. The vapor mixture was bubbled in molten bath through multiple dip tubes in self agitated bath. Initial concentration of TiCl₃ was raised to 20% w/w. The TiCl₃ rich reduction mass was circulated with the electrolysis cell.

Electrolysis was carried in tandem with the reduction at constant 5% w/w TiCl₃ concentration in the NaCl-KCl molten salt to produce 2000 g/h of titanium metal from TiCl₃. The electrolyte depleted in TiCl₃ concentration was made up by circulation of TiCl₃ rich reduction mass into electrolyte. The reduction of TiCl₄ was continued at the same rate of producing 6416 g/hr TiCl₃. The un-reacted TiCl₄ and H₂ were recycled for reduction.

Technical Advancement:

The process of the present invention provides reduction of TiCl₄ by hydrogen and in-situ formation of lower chlorides of Titanium, more particularly TiCl₃ and TiCl₂ in the form of stable complexes.

The process of the present invention avoids escape of Titanium tetrachloride or lower chlorides generated as intermediate products by trapping and de-volatilizing with alkali metal salt.

The process of the present invention recovers the un-reacted TiCl₄ and recycles the recovered TiCl₄.

The process also involves recycling of excess hydrogen after absorbing the HCl formed.

The lower chlorides produced by the present invention are further used to produce titanium.

While considerable emphasis has been placed herein on the specific features of the preferred embodiment, it will be appreciated that many additional features can be added and that many changes can be made in the preferred embodiment without departing from the principles of the invention. These and other changes in the preferred embodiment of the invention will be apparent to those skilled in the art from the disclosure herein, whereby it is to be distinctly understood that the foregoing descriptive matter is to be interpreted merely as illustrative of the invention and not as a limitation.

1. A process for the preparation of lower chlorides of Titanium; said process comprising reduction of Titanium Tetrachloride (TiCl₄) using a reducing agent in at least one molten alkali metal salt at a temperature of about 300 to about 1400° C. to obtain a reduced mass containing lower chlorides of Titanium.

2. The process as claimed in claim 1, wherein the reducing agent is hydrogen (H₂).

3. The process as claimed in claim 1, wherein the mole ratio of H₂ to TiCl₄ is in the range of about 1:1 to 8:1, preferably the mole ratio of H₂ to TiCl₄ is 1:1.

4. The process as claimed in claim 1, wherein the alkali metal salt is at least one selected from the group consisting potassium chloride, sodium chloride, calcium chloride, lithium chloride and magnesium chloride.

5. The process as claimed in claim 1, wherein the lower chlorides of Titanium is at least one selected from the group consisting of titanium trichloride(TiCl₃) and titanium dichloride(TiCl₂).

6. The process as claimed in claim 1, wherein the reduction is carried out at sub-atmospheric to atmospheric pressure using suitable condensing equipment.

7. The process as claimed in claim 1, wherein the reduction is carried out at a pressure up to 20 kg/cm².

8. The process as claimed in claim 1, further comprises heating the reduced mass at a temperature not less than 1000° C. in a disproportionation reactor to obtain lower chlorides of Titanium.

9. The process as claimed in claim 1, further comprises passing the reduced mass in a metallothermic reaction system containing at least one reducing metal selected from the group consisting titanium, aluminium, calcium, magnesium and sodium to produce lower chlorides of the titanium or its alloys.

10. The process as claimed in claim 1, further comprises introducing the reduced mass containing TiCl₃ into an electrolysis cell in which the spent bath with depleted or exhausted lower chlorides is used as a medium for electrolytic reduction to obtain titanium metal.

11. The process as claimed in claim 1, further comprises recycling of un-reacted or recovered TiCl₄.

12. The process as claimed in claim 1, further comprises recycling of excess reducing agent after absorbing the hydrogen chloride formed.
